(19) United States
(12) Patent Application Publication
(10) Pub. No.: US 2026/0235973 A1
(43) Pub. Date: Aug. 13, 2026

(54) TONER AND METHOD OF PRODUCING TONER

(71) Applicant: CANON KABUSHIKI KAISHA, Tokyo (JP)

(72) Inventors: HISASUKE KAJIHARA, Ibaraki (JP); KOUICHIROU OCHI, Chiba (JP); GAKU SATO, Chiba (JP); TAKESHI OHTSU, Ibaraki (JP)

(21) Appl. No.: 19/462,412

(22) Filed: Jan. 28, 2026

(30) Foreign Application Priority Data
Feb. 7, 2025 (JP) 2025-019386

(51) Int. Cl. G03G 9/09; G03G 9/087

(52) U.S. Cl. CPC G03G 9/0924; G03G 9/08755

(57) ABSTRACT

Provided is a toner having a toner particle containing a binder resin and C.I. Pigment Yellow 185, wherein the toner has a peak observed at a diffraction angle 2θ=4.00°±0.50° in an X-ray diffraction measurement using CuKα rays of a sample separated from the toner in a specific procedure.

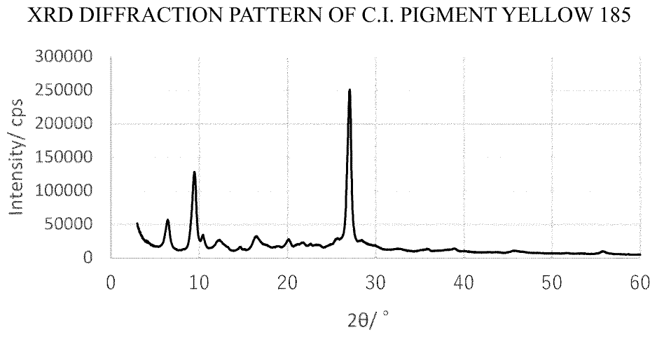

### BACKGROUND

### Field of the Technology

The present disclosure relates to a toner used in an electrophotographic system, an electrostatic recording system, an electrostatic printing system, and a toner jet system, and a method of producing a toner.

### Description of the Related Art

In recent years, full-color multifunction apparatuses based on an electrophotographic system are used widely, and development thereof in the printing market has also advanced. In the printing market, stable output of high quality images is required. In order to satisfy this requirement, the toner is required to exhibit charge retention properties and high tinting strength.

As for a technique for improving the chromogenicity of a yellow toner using C.I. Pigment Yellow 185 (hereinafter also referred to as “PY185”), the techniques described in Japanese Patent Application Laid-open Nos. 2010-002889 and 2024-087789 are known, for example. Suppression of electron transfer in PY185 crystals may realize the improvement of charge retention properties of the toner.

The present inventors have recognized that the toners disclosed in Japanese Patent Application Laid-open Nos. 2010-002889 and 2024-087789 exhibit high tinting strength, but sometimes show insufficient charge retention properties. Specifically, in the techniques described in Japanese Patent Application Laid-open Nos. 2010-002889 and 2024-087789, there is room to improve the charge retention properties of a toner, while maintaining the tinting strength of the yellow toner using PY185.

### SUMMARY

The present disclosure provides a toner that contains PY185 and exhibits excellent charge retention properties and high tinting strength. Further, the present disclosure provides a method for producing a toner that contains PY185 and exhibits excellent charge retention properties and high tinting strength.

The present disclosure is related to a toner comprising a toner particle comprising a binder resin and C.I. Pigment Yellow 185, wherein the toner has a peak observed at a diffraction angle 2θ=4.00°±0.50° in an X-ray diffraction measurement using CuKα rays of a sample separated from the toner in procedure 1 described below:

### Procedure 1:

add 160 g of sucrose to 100 mL of ion-exchanged water and dissolve the sucrose while heating in hot water to prepare a sucrose concentrate solution; put 31 g of the sucrose concentrated solution and 6 mL of a 10 mass % aqueous solution of a pH 7 neutral detergent for precision instrument cleaning comprising a nonionic surfactant, an anionic surfactant, and an organic builder in a centrifugation tube to prepare a mixture; add 2.0 g of the toner to this mixture, and loosen a lump of the toner with a spatula or a similar tool; next, shake the centrifugation tube by a shaker; after shaking, separate a precipitate from a dispersion comprising the toner by a centrifuge under conditions at a rotation speed of 3500 rpm for 30 minutes and a rotation radius of 3 cm; filtrate floating powder in a vacuum filtration apparatus and dry the powder at 40° C. for 1 hour or longer in a drier to obtain a dried powder; dissolve 1 g of the resulting powder in 20 mL of chloroform to form a solution, centrifuge the solution at a rotation speed of 15000 rpm and a rotation radius of 3 cm for 180 minutes, and discard supernatant; further add 20 mL of chloroform thereto, and repeat these operations twice to separate a precipitate; and filtrate a resulting precipitate in a vacuum filtration apparatus, and then dry a resulting solid in a drier at 40° C. for 5 hours or longer to prepare the sample.

In addition, the present disclosure is related to a toner production method for producing the above-mentioned toner, the toner production method comprising: a pigment pulverization step of pulverizing the C.I. Pigment Yellow 185; and a step for producing the toner using the pulverized C.I. Pigment Yellow 185, a pulverizer, which is used in the pigment pulverization step, introducing a dehumidified gas into an apparatus together with a material to be pulverized; and the dehumidified gas introduced having a temperature Tin (° C.) of −10° C. to 40° C.

Features of the present disclosure will become apparent from the following description of embodiments with reference to the attached drawings. The following description of embodiments is described by way of example.

### BRIEF DESCRIPTION OF THE DRAWING

The figure shows an XRD diffraction pattern of PY185 alone.

### DESCRIPTION OF THE EMBODIMENTS

In the present disclosure, “from XX to YY” or “XX to YY” indicating a numerical range means a numerical range including a lower limit and an upper limit that are end points unless otherwise specified. In a case where numerical ranges are described in stages, an upper limit and a lower limit of each numerical range can be combined as desired. Furthermore, in the present disclosure, for example, description such as “at least one selected from the group consisting of XX, YY, and ZZ” means any of XX, YY, ZZ, a combination of XX and YY, a combination of XX and ZZ, a combination of YY and ZZ, or a combination of XX, YY, and ZZ. When XX is a group, multiple XXs may be selected from the group, and the same applies to YY and ZZ.

The present disclosure is related to a toner comprising a toner particle comprising a binder resin and C.I. Pigment Yellow 185, wherein the toner has a peak observed at a diffraction angle 2θ=4.00°±0.50° in an X-ray diffraction measurement using CuKα rays of a sample separated from the toner in procedure 1 described below:

### Procedure 1:

add 160 g of sucrose to 100 mL of ion-exchanged water and dissolve the sucrose while heating in hot water to prepare a sucrose concentrate solution; put 31 g of the sucrose concentrated solution and 6 mL of a 10 mass % aqueous solution of a pH 7 neutral detergent for precision instrument cleaning comprising a nonionic surfactant, an anionic surfactant, and an organic builder in a centrifugation tube to prepare a mixture; add 2.0 g of the toner to this mixture, and loosen a lump of the toner with a spatula or a similar tool; next, shake the centrifugation tube by a shaker; after shaking, separate a precipitate from a dispersion comprising the toner by a centrifuge under conditions at a rotation speed of 3500 rpm for 30 minutes and a rotation radius of 3 cm; filtrate floating powder in a vacuum filtration apparatus and dry the powder at 40° C. for 1 hour or longer in a drier to obtain a dried powder; dissolve 1 g of the resulting powder in 20 mL of chloroform to form a solution, centrifuge the solution at a rotation speed of 15000 rpm and a rotation radius of 3 cm for 180 minutes, and discard supernatant; further add 20 mL of chloroform thereto, and repeat these operations twice to separate a precipitate; and filtrate a resulting precipitate in a vacuum filtration apparatus, and then dry a resulting solid in a drier at 40° C. for 5 hours or longer to prepare the sample.

The above construction provides a toner that contains PY185 and exhibits excellent charge retention properties and high tinting strength. Although the cause remains unclear, the present inventors consider it to be as follows.

First, the charge retention properties of a toner mean that leakage of electrons from the charged toner surface is suppressed and the charge amount of the toner is stable. It is believed that the transferability of the electrons existing among PY185 molecules in the layered electronic state can be controlled by adjusting the distance between the PY185 molecules. It is believed that if the distance between the PY185 molecules is increased to a certain extent, the formation of layered electronic states among PY185 molecules weakens, and electron transfer between PY185 molecules becomes difficult.

When the toner is charged, PY185 is assumed to receive electrons from the constituent materials, such as the binder resin, in the toner. PY185 particles with intermolecular distances expanded to some extent readily retain received electrons. Therefore, since the leakage of electrons from the charged toner to the outside of the toner is suppressed, it is assumed that the charge retention properties of the toner are enhanced.

One means of increasing the distance between PY185 molecules is to apply compressive stress to the pigment using a rotary pulverizer.

Next, the relationship between the intermolecular distance and the X-ray diffraction peak will be described.

When the crystal is irradiated with X-rays of wavelength λ, strong diffraction X-rays occur at a specific diffraction angle 2θ and a lattice spacing d that satisfy the Bragg condition (2dsinθ=nλ). An X-ray diffraction apparatus can measure the diffraction angle 2θ and the corresponding X-ray intensity. It should be noted that in the present disclosure, a peak satisfying a ratio of the peak intensity at a specific diffraction angle 2θ to the peak intensity at a diffraction angle 2θ=27.00°±0.50° of 0.01 or higher in the XRD diffraction pattern of PY185 is defined as an X-ray diffraction peak.

The figure shows an XRD diffraction pattern of pure PY185 (P0 in the Examples), which exhibits no X-ray diffraction peak at a diffraction angle 2θ=4.00°±0.50°. Pure PY185 (P0) refers to PY185 that has not been subjected to compression loading or a similar process. The figure shows that PY185 has major peaks at diffraction angles 2θ=6.4°, 9.4°, 10.4°, 12.2°, 16.4°, 20.1°, and 27.1°.

It is considered that an interlaminar electron state is formed between the pigment molecules constituting the PY185 crystal. For example, when the intermolecular distance, that is, the lattice spacing, is increased due to the compression loading on the pigment particles, or the like, it is believed that the formation of an interlayer electron state is weakened, making it harder for electrons to transfer. Accordingly, it is presumed that if the lattice spacing of the pigment crystals is moderately expanded, the charge retention properties of the toner become high.

When the PY185 has a peak at a diffraction angle 2θ=4.00°±0.50°, PY185 crystals have PY185 intermolecular distances that are wider than P0. In this case, it is inferred that the layered electronic state between pigment molecules is weaker, charge leakage is more difficult to occur, and the charge retention properties are better than those in the case (P0) where the PY185 has no peak at 20=4.00°±0.50°.

In the present disclosure, an X-ray diffraction measurement is carried out by using a sample separated from the toner by the procedure 1 described above. Procedure 1 enables the separation of PY185 contained within the toner particle as a sample.

When the XRD diffraction pattern of PY185 has an X-ray diffraction peak in the range of a diffraction angle 2θ=4.00°±0.50°, the PY185 intermolecular distance becomes moderate. This moderates the formation of interlaminar electron states among PY185 molecules and suppresses the transfer of electrons among PY185 molecules. When the toner is electrically charged, PY185 readily holds electrons received from constituent materials, such as the binder resin, in the toner. Therefore, it is inferred that since the leakage of electrons from the charged toner to the outside of the toner is suppressed, the charge retention properties of the toner are improved.

On the contrary, a case where the XRD diffraction pattern of PY185 has an X-ray diffraction peak at a diffraction angle of less than 2θ=3.50° means that the distance between PY185 molecules is too long. Organic pigment molecules, including PY185 molecules, absorb visible light and exhibit color development due to π-π* transitions, or n-π* transitions. However, if the distance between PY185 molecules is too long, the electron transition induced by visible light absorption on PY185 molecules hardly occurs, resulting in lowered tinting strength.

A case where the XRD diffraction pattern of PY185 has an X-ray diffraction peak at a position exceeding a diffraction angle 2θ=4.50° means that the distance between PY185 molecules is short, and the formation of the layered electronic state among the molecules of the pigment is strong. As a result, electrons are easy to transfer among PY185 molecules, and electrons in PY185 crystals composed of PY185 molecules also readily transfer. As a result, the toner is charged, and when PY185 receives electrons, it is difficult for PY185 pigment particles to retain the received electrons. Therefore, it is presumed that the leakage of electric charge is liable to occur, and the charge retention properties are lowered.

As described above, it is believed that when a peak is observed within the range of a diffraction angle 2θ=4.00°±0.50° in an X-ray diffraction measurement of a sample separated from a toner containing PY185 in accordance with procedure 1, excellent charge retention properties and high tinting strength are exhibited.

In an X-ray diffraction measurement using CuKα rays of a sample separated from the toner, it is preferable that a peak be observed at a diffraction angle 2θ=4.00°±0.20°, it is more preferable that a peak be observed at a diffraction angle 2θ=4.100±0.10°, and it is still more preferable that a peak be observed at a diffraction angle 2θ=4.15°±0.05°. Within the above range, charge retention properties and tinting strength are improved.

The peak position can be controlled by the strength when a compression load is applied to the pigment by a pulverizer or a similar machine. As strength increases, the peak tends to shift toward the lower angle side. As strength decreases, the peak tends to shift toward the higher angle side.

It is preferred that a peak be observed at a diffraction angle 2θ=27.00°±0.50° in an X-ray diffraction measurement using CuKα rays of a sample separated from the toner. The ratio of the peak intensity at a diffraction angle 2θ=4.00°±0.50° to the peak intensity at a diffraction angle 2θ=27.00°±0.50° (peak intensity of 4.00°±0.50°/peak intensity of 27.00°±0.50°) is, for example, 0.04 to 1.15, preferably 0.10 to 1.00, more preferably 0.60 to 0.90, and still more preferably 0.75 to 0.88.

A peak intensity ratio within the above range makes the lattice spacing of pigment crystals, that is, the PY185 intermolecular distance, more moderate, thereby improving charge retention properties.

The peak intensity ratio increases by increasing pulverizing strength. Further, the peak intensity ratio tends to decrease as the pulverizing strength is weakened.

Further, it is inferred that by setting the crystallites of PY185 to an optimum size, the light absorption characteristics of the pigment are more moderate, and the toner using PY185 exhibits further higher tinting strength. A crystallite is a fine single crystal constituting crystals, and the crystals are considered to be polycrystals composed of aggregated single crystals. The size of a crystallite is called the crystallite diameter. The smaller the crystallite diameter, the greater the number of interfaces between crystallites within the pigment crystals.

When the number of interfaces between crystallites is large, resistance to electron transfer within the pigment crystals is high. Therefore, in the charged toner, the pigment particles can readily retain electrons received from the constituent materials, such as the binder resin, in the toner. Therefore, it is inferred that since the leakage of electrons from the charged toner to the outside of the toner is suppressed, the charge retention properties of the toner are improved.

It is preferable that the crystallite diameter satisfy the following condition. That is, it is preferred that a peak be observed at a diffraction angle 2θ=27.00°±0.50° in an X-ray diffraction measurement using CuKα rays of the sample separated from the toner. The crystallite diameter of crystals attributed to the diffraction angle 2θ=27.00°±0.50° is, for example, 8.8 to 13.7 nm, preferably 10.0 to 13.0 nm, more preferably 11.0 to 13.0 nm, and still more preferably 12.0 to 12.9 nm.

A crystallite diameter of the pigment falling within the above range results in an optimal number of interfaces between the crystallites constituting the pigment particles. This makes electron transfer more difficult, thereby improving charge retention properties. In addition, it is presumed that a crystallite diameter of a pigment falling within the above range results in moderate light absorption characteristics of pigment crystals, thereby exhibiting higher tinting strength.

The smaller the crystallite diameter, the greater the number of interfaces and the greater the resistance electrons encounter, which is thus considered advantageous for charge retention properties. Therefore, the crystallite diameter is preferably 13.0 nm or smaller. In addition, from the viewpoint of improving light absorption characteristics and tinting strength, the crystallite diameter is preferably 9.0 nm or larger.

The crystallite diameter of the pigment can readily increase by decreasing the pulverization strength. Further, the crystallite diameter of the pigment can readily decrease by increasing pulverization strength.

The present disclosure also relates to a method for producing the toner. The method for producing the toner includes, for example, a pigment pulverization step of pulverizing C.I. Pigment Yellow 185 and a step of producing a toner using the pulverized C.I. Pigment Yellow 185.

The pulverizer used in the pigment pulverization step is preferably one into which dehumidified gas is introduced together with the material to be pulverized. Then, the temperature Tin of the introduced dehumidified gas is, for example, −12° C. to 42° C., preferably −10° C. to 40° C., and more preferably −8° C. to 0° C.

In a pulverizer, dehumidified gas is introduced into the apparatus together with the material to be pulverized, and the material to be pulverized is pulverized while being accompanied by the dehumidified gas. Further, the pulverizer discharges the introduced dehumidified gas to the outside after the pulverization treatment. Examples of such a pulverizer may include the Turbo Mill (Freund-Turbo Corporation). As alternatives to a rotary pulverizer, known pulverizers can be used. For example, a pulverizer described later, which can be used when a toner is produced by a pulverization method, may be used.

It is presumed that a temperature Tin of the dehumidified gas introduced into the apparatus falling within the above range results in a moderate quantity of heat to PY185 and does not largely change the crystal form of the pigment, whereby the toner using the pulverized pigment PY185 exhibits higher tinting strength. In addition, a temperature Tin of the dehumidified gas introduced into the apparatus within the above range results in a moderate lattice spacing in crystals during pigment pulverization, thereby moderating electron transport among pigment molecules and improving charge retention properties.

The temperature Tout (° C.) of the dehumidified gas discharged to the outside of the pulverizer is, for example, 18° C. to 62° C., and preferably, 20° C. or higher and lower than 60° C.

A temperature Tout of the dehumidified gas discharged to the outside of the pulverizer falling within the above range means that the cooling ability with respect to the pulverization strength is sufficient. Therefore, it is believed that the crystal form of the pigment is maintained, and the toner using the pulverized PY185 exhibits higher tinting strength. The temperature mentioned above is a temperature range that is sensitive to the lattice spacing of pigment pulverization. A temperature falling within this temperature range results in a moderate lattice spacing of crystals and better charge retention properties. One method for keeping the temperature of the discharged dehumidified gas within the range of the temperature Tout described above is to control the temperatures of the cooling water and the dehumidified gas.

The following describes the individual components of the toner.

### Binder Resin

The toner contains a toner particle. The toner particle contains a binder resin. As the binder resin, known polymers can be used. Specifically, the following polymers can be used, for example.

The weight-average molecular weight M_{w} of the binder resin is preferably 5000 to 100000, or 20000 to 80000.

Homopolymers of styrene and a substituted compound thereof, such as polystyrene, poly-p-chlorostyrene, and polyvinyltoluene; styrenic copolymers, such as a styrene-p-chlorostyrene copolymer, a styrene-vinyltoluene copolymer, a styrene-vinylnaphthalene copolymer, a styrene-acrylic acid ester copolymer, a styrene-methacrylic acid ester copolymer, a styrene-methyl α-chloromethacrylate copolymer, a styrene-acrylonitrile copolymer, a styrene-vinyl methyl ether copolymer, a styrene-vinyl ethyl ether copolymer, a styrene-methyl vinyl ketone copolymer, and a styrene-acrylonitrile-indene copolymer; polyvinyl chloride, phenolic resins, natural resin-modified phenolic resins, natural resin-modified maleic acid resins, acrylic resins, methacrylic resins, polyvinyl acetate, silicone resins, polyester resins, polyurethane resins, polyamide resins, furan resins, epoxy resins, xylene resins, polyvinyl butyral, terpene resins, coumarone-indene resins, petroleum-based resins, and other polymers. These resins may be used singly or in combination of two or more types thereof.

For example, the binder resin contains a polyester resin, preferably an amorphous polyester resin. The binder resin preferably contains, for example, 50 to 100 mass %, or 80 to 100 mass % of an amorphous polyester resin.

As the amorphous polyester resin, a condensation polymerization product of a carboxylic acid component and an alcohol component, which will be listed below, may be used.

The carboxylic acid component may be at least one selected from the group consisting of terephthalic acid, isophthalic acid, phthalic acid, fumaric acid, maleic acid, dodecenylsuccinic acid, cyclohexanedicarboxylic acid, and trimellitic acid.

The alcohol component may be at least one selected from the group consisting of bisphenol A, hydrogenated bisphenol, an ethylene oxide (1 to 5 moles, for example) adduct of bisphenol A, a propylene oxide (1 to 5 moles, for example) adduct of bisphenol A, glycerin, trimethylol propane, and pentaerythritol.

The binder resin may contain a crystalline polyester resin. The crystalline polyester resin is preferably a condensation polymerization product of alcohols containing an aliphatic diol having from 2 to 23 carbon atoms and carboxylic acids containing an aliphatic dicarboxylic acid having from 3 to 24 carbon atoms.

The crystalline polyester resin is preferably a condensation polymerization product of alcohols containing from 80 to 100 mol % (still more preferably from 85 to 100 mol %) of an aliphatic diol having from 4 to 12 carbon atoms relative to all alcohols constituting the crystalline polyester resin and carboxylic acids containing from 80 to 100 mol % (still more preferably from 85 to 100 mol %) of an aliphatic dicarboxylic acid having from 4 to 20 carbon atoms relative to all carboxylic acids constituting the crystalline polyester resin.

The aliphatic diol is preferably a linear aliphatic diol, and examples thereof may include 1,4-butanediol, 1,5-pentanediol, 1,6-hexanediol, 1,7-heptanediol, 1,8-octanediol, 1,9-nonanediol, 1,10-decanediol, and 1,12-dodecanediol, and derivatives thereof. The derivative is not particularly limited as long as similar resin structures can be obtained by condensation polymerization. For example, esterified derivatives of the diols may be mentioned.

The aliphatic dicarboxylic acid is preferably a linear aliphatic dicarboxylic acid, and examples thereof may include malonic acid, succinic acid, glutaric acid, adipic acid, pimelic acid, suberic acid, glutaconic acid, azelaic acid, sebacic acid, hexadecanedioic acid, eicosanedioic acid, derivatives thereof, and the like. The derivative is not particularly limited as long as similar resin structures can be obtained by condensation polymerization. For example, an anhydride of the dicarboxylic acid and derivatives obtained by converting a dicarboxylic acid component into alkyl esters or acid chlorides may be mentioned.

Meanwhile, a carboxylic acid other than the aliphatic dicarboxylic acid may be used in combination.

The content of the crystalline polyester resin relative to the toner particle is preferably 0.1 to 5.0 mass %, and more preferably 1.0 to 4.0 mass % from the perspective of improving abrasion resistance.

### Colorant

The toner particle contains a yellow colorant. Specifically, the toner particle contains C.I. Pigment yellow 185. The toner particles may further contain the following yellow toner pigment and yellow toner dye to the extent that the effects of the present disclosure are not impaired.

Examples of yellow toner pigments may include the following ones. C.I. Pigment Yellow 1, 2, 3, 4, 5, 6, 7, 10, 11, 12, 13, 14, 15, 16, 17, 23, 62, 65, 73, 74, 83, 93, 94, 95, 97, 109, 110, 111, 120, 127, 128, 129, 147, 151, 154, 155, 168, 174, 175, 176, 180, and 181; and C.I. Vat Yellow 1, 3, and 20.

Examples of yellow toner dyes may include C.I. Solvent Yellow 162.

The content of the colorant in the toner is preferably from 1 to 20 parts by mass relative to 100 parts by mass of the binder resin.

The content ratio of the Pigment Yellow 185 in the toner particle is preferably 1 to 20 mass %, more preferably 3 to 20 mass %, and still more preferably 5 to 15 mass %.

### Release Agent

The toner particles may contain a release agent. Examples of release agents may include the following ones: hydrocarbon waxes (low molecular weight polyolefins, such as polyethylene; ozokerite, ceresin, paraffin wax, microcrystalline wax, Fischer-Tropsch wax); silicones having a melting point; fatty acid amides, such as oleamide, erucamide, ricinoleamide, and stearamide; ester waxes, such as stearyl stearate; plant-based waxes, such as carnauba wax, rice wax, candelilla wax, wood wax, and jojoba oil; animal-based waxes such as beeswax; montan wax, mineral-based waxes; and modifications thereof.

The toner particle preferably contains a hydrocarbon wax. The release agent may be used singly, or two or more thereof may be used as a mixture.

The melting point of the release agent is preferably 150° C. or lower, more preferably from 40° C. to 130° C., and still more preferably from 40° C. to 110° C. The content of the release agent is preferably from 1 to 30 parts by mass relative to 100 parts of the binder resin.

### Inorganic Fine Particle

The toner may contain an inorganic fine particle. The inorganic fine particle may be internally added to the toner particle or mixed with the toner as an external additive. Examples of inorganic fine particles may include fine particles, such as silica fine particles, titanium oxide fine particles, alumina fine particles, or complex oxide fine particles thereof. Among inorganic fine particles, silica fine particles and titanium oxide fine particles are preferred for the improvement of flowability and uniform charging. The inorganic fine particles are preferably hydrophobized with a hydrophobic agent, such as a silane compound, a silicone oil, or a mixture thereof.

The external additive content is preferably from 0.1 to 10.0 parts by mass relative to 100 parts by mass of the toner particle. The toner particle and the external additive may be mixed using a known mixer, such as a Henschel mixer.

### Method of Producing Toner

Hereinafter, a procedure for producing the toner will be described. As described above, the method for producing the toner includes, for example, a pigment pulverization step of pulverizing C.I. Pigment Yellow 185 and a step of producing a toner using the pulverized C.I. Pigment Yellow 185.

In the step of producing the toner, known methods, such as emulsion aggregation methods, pulverization methods, suspension polymerization methods, and similar methods, may be used without any particular limitation. Hereinafter, a pulverization method will be described as an example.

### Pigment Pulverization Step

C.I. Pigment Yellow 185 can be pulverized by using a pulverizer, such as a rotary pulverizer. As a result, compression load is applied to the pigment particles, and the lattice spacing of the pigment crystals can be expanded.

In the pigment pulverization step, it is preferred that the temperature Tin (° C.) of the dehumidified gas introduced into the rotary pulverizer and the temperature Tout (° C.) of the discharged dehumidified gas satisfy the ranges described above.

Using pulverized C.I. Pigment Yellow 185, a toner can be produced according to the following procedure.

### Raw Material Mixing Step

In the raw material mixing step, predetermined amounts of a binder resin and colorant particles, such as pulverized C.I. Pigment Yellow 185, are weighed and mixed. The mixing apparatus is not particularly limited, but examples thereof may include Henschel mixer (manufactured by Nippon Coke & Engineering Co., Ltd.); SUPERMIXER (manufactured by Kawata Mfg. Co., Ltd.); RIBOCONE (manufactured by Okawara Mfg. Co., Ltd.); Nauta Mixer, Turbulizer, Cyclomix (manufactured by Hosokawa Micron Group); Spiral Pin Mixer (manufactured by Pacific Machinery & Engineering Co., Ltd.); Loedige mixer (manufactured by MATSUBO Corporation), and the like.

### Melt-Kneading Step

The raw material mixture mixed in the raw material mixing step is melt-kneaded by a twin-screw extruder or a similar machine. In the melt kneading step, a batch kneader, such as a pressurizing kneader or a Banbury mixer, and a continuous kneader may be used, as an alternative to a twin-screw extruder. From the perspective of the advantages of continuous production, a single- or twin-screw extruder is preferred. The temperature during melt-kneading is preferably about 100° C. to 2θ0° C.

### Pulverization Step

The pulverization step is a step of cooling the resulting kneaded product after the melt-kneading step so that the resulting kneaded product reach pulverizable hardness, and mechanically pulverizing the kneaded product into a toner particle diameter by means of a known pulverizer, such as a collision plate-type jet mill, a fluidized bed-type jet mill, or a rotary mechanical mill. Examples of pulverizers may include Counter Jet Mill, Micron Jet, Innomizer (manufactured by Hosokawa Micron Corporation); IDS mill, PJM Jet Mill (manufactured by Nippon Pneumatic Mfg. Co., Ltd.); CROSSJET mill (manufactured by Kurimoto, Ltd.); ULMAX (manufactured by Nisso Engineering Co., Ltd.); SK Jet O'Mill (manufactured by Seishin Enterprise Co., Ltd.); KRYPTRON (manufactured by Kawasaki Heavy Industries, Ltd.); Turbo Mill (manufactured by Turbo Kogyo Co., Ltd.); Super Rotor (Nisshin Engineering Inc.); and the like. From the perspective of pulverization efficiency, it is desirable to use a fluidized bed jet mill as the pulverizer.

### Classification Step

The classification step is a step of classifying the finely pulverized substance obtained in the pulverization step to produce a toner particle with the desired particle size distribution.

As classifiers used for classification, known devices, such as an air classifier, an inertial classifier, and a sieve classifier, may be used. Specific examples thereof may include Classeal, Micron Classifier, Spedic Classifier (Seishin Enterprise Co., Ltd.); Turbo Classifier (Nisshin Engineering Inc.); Micron Separator, Turboplex (ATP), TSP separator (manufactured by Hosokawa Micron Corporation); Elbow-Jet (manufactured by Nittetsu Mining Co., Ltd.); Dispersion Separator (manufactured by Nippon Pneumatic Mfg. Co., Ltd.); and YM Micro Cut (manufactured by Yaskawa Shoji Co., Ltd.).

### External Addition Step

If necessary, inorganic fine particles, such as silica, alumina, and titania, or resin particles, such as vinyl-based resins, polyester resins, and silicone resins, may be added to the toner particle prepared through the above steps by applying a shearing force in a dry state. These inorganic fine particles and resin fine particles function as external additives, such as flow aids and cleaning aids.

The weight-average particle diameter of the toners is preferably from 3.0 μm to 10.0 μm, more preferably from 4.0 μm to 8.0 μm.

### EXAMPLES

Hereinafter, the present disclosure will be more specifically described with reference to Examples and Comparative Examples, which do not limit the present disclosure at all.

### Production of Pigments P1 to P21

P1 was produced by pulverizing PY185 using a rotary pulverizer. Unpulverized PY185 is designated as P0. Paliotol Yellow D1155, manufactured by DIC Corporation, was used as P0.

P1 was obtained by pulverizing P0 according to the following conditions: in a mechanical pulverizer (T-250, Turbo Industry Co., Ltd.), liner-to-rotor gap was set to 1.0 mm, the number of revolutions of the rotor was set to 10000 rpm, the feeding rate was set to 5 kg/hr, the cooling water temperature was set to −5° C., and the air flow was set to 8 m³/min, and the pigment P0 was then fed to produce a pulverized pigment P1. At this time, the temperature Tin of the dehumidified cold air introduced into the apparatus was −5° C., and the temperature Tout of the dehumidified gas discharged to the outside of the pulverizer was 25° C.

Also, pulverized pigments P2 to P21 were obtained by changing the pulverizing conditions as shown in Table 1.

TABLE 1

| | | | | | | Temperature | Temperature |
|---|---|---|---|---|---|---|---|
| | | | Number of | Cooling | | Tin of | Tout of |
| | Feeding | Liner-to-rotor | revolutions | water | | dehumidified | dehumidified |
| Pulverized | amount | gap interval | of rotor | temperature | Air flow | gas | gas |
| pigment | kg/hr | mm | rpm | ° C. | m³/min | ° C. | ° C. |
| P 1 | 5 | 1.0 | 10000 | −5 | 8 | −5 | 25 |
| P 2 | 2 | 1.0 | 10000 | −5 | 8 | −5 | 19 |
| P 3 | 3 | 1.0 | 10000 | −5 | 8 | −5 | 21 |
| P 4 | 10 | 1.0 | 10000 | −5 | 8 | −5 | 59 |
| P 5 | 15 | 1.0 | 10000 | −5 | 8 | −5 | 61 |
| P 6 | 2 | 1.0 | 10000 | −10 | 8 | −11 | 19 |
| P 7 | 2 | 1.0 | 10000 | −7 | 8 | −9 | 19 |
| P 8 | 15 | 1.0 | 10000 | −3 | 8 | 39 | 61 |
| P 9 | 15 | 1.0 | 10000 | −2 | 8 | 41 | 61 |
| P 10 | 2 | 1.0 | 11500 | −7 | 8 | −11 | 19 |
| P 11 | 2 | 1.0 | 11000 | −7 | 8 | −11 | 19 |
| P 12 | 2 | 1.0 | 9000 | −7 | 8 | −11 | 19 |
| P 13 | 2 | 1.0 | 8000 | −7 | 8 | −11 | 19 |
| P 14 | 2 | 2.0 | 11500 | −7 | 8 | −11 | 19 |
| P 15 | 2 | 1.5 | 11500 | −7 | 8 | −11 | 19 |
| P 16 | 2 | 0.8 | 11500 | −7 | 8 | −11 | 19 |
| P 17 | 2 | 0.5 | 11500 | −7 | 8 | −11 | 19 |
| P 18 | 2 | 0.5 | 7500 | −7 | 8 | −11 | 19 |
| P 19 | 2 | 0.5 | 9500 | −7 | 8 | −11 | 19 |
| P 20 | 2 | 0.5 | 8000 | −7 | 8 | −11 | 19 |
| P 21 | 2 | 0.5 | 9000 | −7 | 8 | −11 | 19 |

### Production of Toner Particle 1

Amorphous polyester A (composition (mol %) [polyoxypropylene(2.2)-2,2-bis(4-hydroxyphenyl)propane:isophthalic acid:terephthalic acid=100:50:50], weight-average molecular weight=50500): 81.0 parts by mass
Pigment: Pigment Yellow 185 P1: 10.0 parts by mass
Hydrocarbon wax 1: 9.0 parts by mass
Peak temperature of the maximum endothermic peak: 90 degrees

The above materials were mixed using a Henschel mixer (FM-75 model, manufactured by Mitsui Mining Corporation) at a number of revolutions of 20 s⁻¹ and a rotation time of 5 min, and were then kneaded in a two-screw kneader (PCM-30 model, manufactured by Ikegai Corporation). The resulting kneaded product was cooled and coarsely pulverized to a weight-average particle diameter of 100 μm or less using a pin mill, thereby obtaining a coarsely pulverized product. The resulting coarsely pulverized product was finely pulverized by means of a mechanical pulverizer (T-250, manufactured by Turbo Industry Co., Ltd.) while adjusting the number of revolutions or the number of passes so as to achieve the target particle diameter.

Further, classification was carried out using a rotary classifier (200TSP, manufactured by Hosokawa Micron Corporation) to obtain toner particle 1. With respect to the operating condition of a rotary classifier (200TSP, manufactured by Hosokawa Micron Corporation), classification was carried out by adjusting the number of revolutions so as to obtain the target particle diameter and particle size distribution.

### Production of Toner 1

Toner particle 1: 100 parts by mass
Silica fine particle L: 1.8 parts by mass
Silica Fine Particle S: 0.8 parts by mass

The materials listed above were mixed using a Henschel mixer (FM-75 model manufactured by Mitsui Mining Corporation) at a number of revolutions of 30 s⁻¹ for a rotation time of 10 min to obtain toner 1. The weight-average particle diameter of the toner was 6.5 μm.

Silica fine particle L is an external additive particle with a peak in the range from 50 nm to 300 nm in the particle diameter distribution and a number-average particle diameter of the external additive particles within 50 nm to 300 nm of 110 nm, the external additive particle being subjected to a hydrophobic treatment with silicone oil. Silica fine particle S is an external additive particle with a peak in the range from 20 nm to 50 nm in the particle diameter distribution and a number-average particle diameter of 40 nm, the external additive particle being subjected to a hydrophobic treatment with silicone oil.

### Production of Toner Particles 2 to 19 and Comparative Toner Particles 1 to 3

Toner particles 2 to 19 and comparative toner particles 1 to 3 were obtained in the same manner as in the production example of toner particle 1, except that the pigments used were changed to those listed in Table 2 in the production of toner particle 1.

TABLE 2

| Examples/ | | | |
|---|---|---|---|
| Comparative | | | |
| Examples | Toner | Toner particle | Pigment |
| Example 1 | Toner 1 | Toner particle 1 | P1 |
| Example 2 | Toner 2 | Toner particle 2 | P2 |
| Example 3 | Toner 3 | Toner particle 3 | P3 |
| Example 4 | Toner 4 | Toner particle 4 | P4 |
| Example 5 | Toner 5 | Toner particle 5 | P5 |
| Example 6 | Toner 6 | Toner particle 6 | P6 |
| Example 7 | Toner 7 | Toner particle 7 | P7 |
| Example 8 | Toner 8 | Toner particle 8 | P8 |
| Example 9 | Toner 9 | Toner particle 9 | P9 |
| Example 10 | Toner 10 | Toner particle 10 | P10 |
| Example 11 | Toner 11 | Toner particle 11 | P11 |
| Example 12 | Toner 12 | Toner particle 12 | P12 |
| Example 13 | Toner 13 | Toner particle 13 | P13 |
| Example 14 | Toner 14 | Toner particle 14 | P14 |
| Example 15 | Toner 15 | Toner particle 15 | P15 |
| Example 16 | Toner 16 | Toner particle 16 | P16 |
| Example 17 | Toner 17 | Toner particle 17 | P17 |
| Example 18 | Toner 18 | Toner particle 18 | P18 |
| Example 19 | Toner 19 | Toner particle 19 | P19 |
| Comparative | Comparative | Comparative | P0 |
| Example 1 | Toner 1 | Toner particle 1 | |
| Comparative | Comparative | Comparative | P20 |
| Example 2 | Toner 2 | Toner particle 2 | |
| Comparative | Comparative | Comparative | P21 |
| Example 3 | Toner 3 | Toner particle 3 | |

### Production of Toners 2 to 19 and Comparative Toners 1 to 3

Toners 2 to 19 and comparative toners 1 to 3 were obtained in the same manner as in the production example of toner 1, except that the types of toner particles used were changed to those listed in Table 2 in the production of toner particle 1.

X-ray Diffraction Measurement of Samples Extracted from Toners 1 to 19 and Comparative Toners 1 to 3

First, an extracted sample was obtained from the toner according to the following procedure 1.

### Procedure 1:

160 g of sucrose was added to 100 mL of ion-exchanged water and dissolved while heating in hot water to prepare a sucrose concentrate solution. 31 g of the sucrose concentrated solution and 6 mL of a 10 mass % aqueous solution of a pH 7 neutral detergent for precision instrument cleaning comprising a nonionic surfactant, an anionic surfactant, and an organic builder were put in a centrifugation tube to prepare a mixture. 2.0 g of the toner was added to this mixture, and a lump of the toner was loosened with a spatula or a similar tool.

Next, the centrifugation tube was shaken by a shaker. After shaking, a precipitate was separated from a dispersion comprising the toner by a centrifuge under conditions at a rotation speed of 3500 rpm for 30 minutes and a rotation radius of 3 cm. A floating powder was filtrated in a vacuum filtration apparatus and the powder was dried at 40° C. for 1 hour or longer in a drier to obtain a dried powder. 1 g of the resulting powder was dissolved in 20 mL of chloroform to form a solution, the solution was centrifuged at a rotation speed of 15000 rpm and a rotation radius of 3 cm for 180 minutes, and supernatant was discarded.

Further 20 mL of chloroform was added thereto, and these operations were repeated twice to separate a precipitate. A resulting precipitate was filtrated in a vacuum filtration apparatus, and then a resulting solid was dried in a drier at 40° C. for 5 hours or longer to prepare the sample.

“Contaminon N” manufactured by Wako Pure Chemical Industries, Ltd. can be used as a pH 7 neutral detergent for precision instrument cleaning including a nonionic surfactant, an anionic surfactant, and an organic builder. FRONT LABO FLD2012 (manufactured by AS ONE Corporation) was used as a centrifuge.

As shown in Table 4, the resulting extracted samples were designated E0 and E1 to E21, respectively, corresponding to toners 1 to 19 and comparative toners 1 to 3 that were subjected to the extraction treatment, as shown in Table 3. Then, X-ray diffraction measurements were carried out on E0 and E1 to E21 according to the following method.

The X-ray diffraction measurement uses a measuring instrument, “RINT-TTRII” (manufactured by Rigaku Corporation), along with the control and analysis software attached to the instrument. Measurement conditions are as follows.
X-ray: Cu/50 kV/300 mA
Goniometer: Rotor horizontal goniometer (TTR-2)
Attachment: Standard sample holder
Divergent slit: Release
Divergence vertical restriction slit: 10.00 mm
Scattering slit: Opened
Light-receiving slit: Opened
Counter: Scintillation counter
Scanning mode: Continuous
Scanning speed: 4.0000°/min
Sampling width: 0.02000
Scanning axis: 2θ/θ
Scanning range: 10.0000° to 40.0000°

Subsequently, the extracted sample was placed on the sample plate, and the measurement was started. In CuKα characteristic X-rays, an X-ray diffraction spectrum was obtained in which the Bragg angle was 0, the diffraction angle was 2θ, 2θ being within the range from 3° to 60°, the diffraction angle 2θ was taken as the abscissa, and the X-ray intensity was taken as the ordinate.

If the XRD diffraction pattern of P0 and the XRD diffraction pattern of the extracted sample were coincident with each other, the extracted sample was judged to be PY185. E1 to E21 all had peaks around 2θ=6.2°, 9.3°, 10.2°. 12.2°, 16.3°. 20.10, and 27.0°, which were almost coincident with the peak positions of P0. Thus, the extracted samples were all judged to be PY185. The reason why the peak shifts to the lower-angle side relative to the peak positions of P0 is considered to be that a compression load is applied to the PY185 crystals by the pulverizing treatment during the production of P1 to P21, thereby increasing the distance between the PY185 molecules constituting the PY185 crystals.

E1 to E21 also have peaks around the diffraction angle 2θ=4.00°. Specific peak positions are shown in Table 3. This is believed to be due to an increase in the distance between PY185 molecules, which newly provides lattice spacings such as those satisfying the Bragg diffraction condition.

The distance between the PY185 molecules (lattice spacing) can be changed by changing the conditions of the rotary pulverizer. The peak position around the diffraction angle 2θ=4.00° can be changed according to the strength of pulverization. By increasing the pulverizing strength, the intermolecular distance of PY185 can be further increased, and PY185 has a peak on the lower-angle side than the diffraction angle 2θ=4.00°. When the pulverizing strength is reduced, the intermolecular distance of PPY85 is shorter, and the peak appears on the higher-angle side than the diffraction angle 2θ=4.00°.

Table 3 shows the crystallite diameter calculated from the XRD diffraction pattern of the extracted sample. The size of the crystallite diameter is related to the number of interfaces between crystallites within the crystal. The smaller the crystallite, the greater the number of interfaces. At the interfaces between crystallites, electrons encounter resistance, so the number of interfaces among crystallites affects electron transferability. That is, the smaller the crystallite diameter, the greater the number of interfaces and the larger the resistance electrons encounter, which is thus considered advantageous for chare retention properties.

TABLE 3

| | | | | Peak position | | |
|---|---|---|---|---|---|---|
| | | | | existing around | | |
| | | Pigment | | the diffraction | Peak | Crystallite |
| Example | Toner | used for | Extracted | angle 2θ = 4.00° | intensity | diameter |
| No. | No. | toner | sample | (°) | ratio | (nm) |
| Example 1 | Toner 1 | P1 | E1 | 4.15 | 0.87 | 12.7 |
| Example 2 | Toner 2 | P2 | E2 | 4.18 | 0.84 | 12.4 |
| Example 3 | Toner 3 | P3 | E3 | 4.16 | 0.86 | 12.6 |
| Example 4 | Toner 4 | P4 | E4 | 4.16 | 0.86 | 12.6 |
| Example 5 | Toner 5 | P5 | E5 | 4.17 | 0.85 | 12.5 |
| Example 6 | Toner 6 | P6 | E6 | 4.20 | 0.82 | 12.1 |
| Example 7 | Toner 7 | P7 | E7 | 4.18 | 0.84 | 12.3 |
| Example 8 | Toner 8 | P8 | E8 | 4.18 | 0.84 | 12.3 |
| Example 9 | Toner 9 | P9 | E9 | 4.19 | 0.83 | 12.2 |
| Example 10 | Toner 10 | P10 | E10 | 4.21 | 0.81 | 9.0 |
| Example 11 | Toner 11 | P11 | E11 | 4.20 | 0.82 | 10.5 |
| Example 12 | Toner 12 | P12 | E12 | 4.20 | 0.82 | 12.5 |
| Example 13 | Toner 13 | P13 | E13 | 4.21 | 0.81 | 13.5 |
| Example 14 | Toner 14 | P14 | E14 | 3.70 | 0.09 | 9.0 |
| Example 15 | Toner 15 | P15 | E15 | 3.60 | 0.11 | 9.0 |
| Example 16 | Toner 16 | P16 | E16 | 4.13 | 0.90 | 9.0 |
| Example 17 | Toner 17 | P17 | E17 | 4.11 | 1.10 | 9.0 |
| Example 18 | Toner 18 | P18 | E18 | 3.50 | 1.10 | 9.0 |
| Example 19 | Toner 19 | P19 | E19 | 4.50 | 0.05 | 15.0 |
| Comparative | Comparative | P0 | E0 | No peak | 0 | 20.0 |
| Example 1 | Toner 1 | | | observed | | |
| Comparative | Comparative | P20 | E20 | 3.40 | 1.20 | 9.0 |
| Example 2 | Toner 2 | | | | | |
| Comparative | Comparative | P21 | E21 | 4.60 | 0.07 | 17.0 |
| Example 3 | Toner 3 | | | | | |

In Table 3, the peak positions around a diffraction angle 2θ=4.00° indicates the position of a peak observed around a diffraction angle 2θ=4.00°±0.50° in an X-ray diffraction measurement using CuKα rays of the sample separated from the toner according to procedure 1.

Peak intensity ratio refers to a ratio of a peak intensity at a diffraction angle 2θ =4.00°±0.50° to a peak intensity at a diffraction angle 2θ=27.00°±0.50°.
Production Example of Magnetic Carrier 1
Production Example of Magnetic Core
Step 1 (Weighing/Mixing Step):
Fe₂O₃: 61.7 mass %
MnCO₃: 34.2 mass %
Mg(OH)₂: 3.0 mass %
SrCO₃: 1.1 mass %

Ferrite raw materials were weighed to ensure the composition as listed above.

The mixture was then pulverized and mixed for 2 hours by a dry ball mill using zirconia (φ 10 mm) balls.

### Step 2 (Calcination Step):

After pulverization and mixing, the mixture was fired in air at 950° C. for 2 hours in a burner-type furnace to produce calcined ferrite. The compositions of ferrite are as follows.

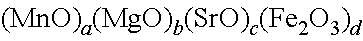

In the above formula, a=0.40, b=0.07, c=0.01, and d=0.52

### Step 3 (Pulverization Step):

After the calcined ferrite was pulverized to about 0.5 mm by a crusher, 30 parts by mass of water were added relative to 100 parts by mass of the calcined ferrite, then the calcined ferrite was pulverized for 2 hours by means of a wet ball mill using zirconia balls (φ 1.0 mm). After removing the balls, the calcined ferrite was pulverized for 3 hours by means of a wet bead mill using zirconia beads (φ 1.0 mm) to obtain a ferrite slurry.

### Step 4 (Granulating Step):

To the ferrite slurry, 2.0 parts by mass of polyvinyl alcohol were added as a binder relative to 100 parts by mass of the calcined ferrite, and the mixture was granulated into spherical particles of 40 μm using a spray drier (manufacturer: Okawara Kakoki, Co., Ltd.).

### Step 5 (Main Firing Step):

In order to control the firing atmosphere, spherical particles were fired in an electric furnace at 1150° C. for 4 hours under a nitrogen atmosphere (oxygen concentration: 1.0 vol %).

### Step 6 (Sorting Step):

After the agglomerated particles were disintegrated, coarse particles were removed by sieving through a 250 μm sieve to obtain porous magnetic core particles.

### Step 7 (Resin Filling Step):

100.0 parts by mass of the porous magnetic core particles were put in a stirring vessel of a mixing stirrer (all-purpose stirrer NDMV model manufactured by Dalton Corporation). Nitrogen was introduced while maintaining the temperature at 60° C. and reducing the pressure to 2.3 kPa. The silicone resin solution was added dropwise under reduced pressure so that the resin component be 7.5 parts by mass relative to the porous magnetic core particles. After the dropwise addition, the stirring was continued for 2 hours.

Thereafter, the temperature was raised to 70° C., the solvent was removed under reduced pressure, and a silicone resin composition obtained from the silicone resin solution was filled into the interior of porous magnetic core particles. After cooling, the resulting filled core particles were transferred to a mixer (a drum mixer, UD-AT model, manufactured by Sugiyama Heavy Industrial) with spiral blades in a rotatable mixing vessel. The temperature was raised to 220° C. at a ramp rate of 2 (° C./min) under a nitrogen atmosphere at atmospheric pressure. The resin was heated and stirred at this temperature for 60 minutes to cure. After heat treatment, low-magnetic materials were separated by magnetic sorting and then classified using a 150 μm sieve to obtain a magnetic core.

### Production Example of Coating Resin

A four-neck flask equipped with a reflux condenser, a thermometer, a nitrogen inlet tube, and a ground-joint stirring device was charged with 80 parts by mass of cyclohexyl methacrylate and 2θ parts by mass of methyl methacrylate.

Further, 100 parts by mass of toluene, 100 parts by mass of methyl ethyl ketone, and 2.0 parts by mass of azobis(isovaleronitrile) were added. The resulting mixture was kept at 70° C. under a nitrogen stream for 10 hours, and after completion of the polymerization reaction, the mixture was washed repeatedly to obtain a coating resin solution (solid content: 35 mass %).

### Production Example of Coating Resin Coating Liquid

Toluene and methyl ethyl ketone were added in a 1:1 ratio to the coating resin solution so that the solid content ratio of the resin be 5 mass %. The resulting mixture was stirred with shaking for 15 minutes using a paint shaker (manufactured by RADIA) to obtain a coating resin coating solution.

### Production Example of Magnetic Carrier

Using a magnetic core, the coating resin coating liquid was fed into a planetary mixer (Nauta Mixer VN model manufactured by Hosokawa Micron Corporation), which was maintained at a temperature of 60° C. under reduced pressure (1.5 kPa) so that the solid content be 3.0 parts by mass relative to 100 parts by mass of the magnetic core. As a feeding method, a ⅓ portion of the resin coating liquid was fed, and solvent removal and coating operations were performed for 20 minutes. Next, another ⅓ portion of the resin coating liquid was fed, and solvent removal and coating operations were performed for 20 minutes. Then, still another ⅓ portion of the resin coating liquid was fed, and solvent removal and coating operations were performed for 20 minutes.

Thereafter, the resulting mixture was transferred to a mixer (drum mixer UD-AT model manufactured by Sugiyama Heavy Industrial) equipped with spiral blades in a rotatable mixing vessel, and the mixture was heat-treated at 120° C. for 2 hours under a nitrogen atmosphere while stirring by rotating the mixing vessel at 10 revolutions per minute. Low-magnetic-field products were removed from the resulting mixture by magnetic sorting. The mixture from which low-magnetic-field products had been removed was passed through a 150 μm sieve, and then classified using an air classifier to obtain magnetic carrier 1.

### Production Example of Two-Component Developer 1

To 92.0 parts of magnetic carrier 1, 8.0 parts of toner 1 were added, and mixed using a V-type mixer (V-20 manufactured by Seishin Enterprise Co., Ltd.) to obtain two-component developer 1.

### Production Examples of Developers 2 to 19 and Comparative Developers 1 to 3

Developers 2 to 19 and comparative developers 1 to 3 were obtained through the same operations, except that combinations of toners 2 to 19 and comparative toners 1 to 3 were changed in the production example of two-component developer 1.

TABLE 4

| Examples/ | | | |
|---|---|---|---|
| Comparative | Two-component | | |
| Examples | developer | Toner | Magnetic carrier |
| Example 1 | Two-component | Toner 1 | Magnetic carrier 1 |
| | developer 1 | | |
| Example 2 | Two-component | Toner 2 | Magnetic carrier 1 |
| | developer 2 | | |
| Example 3 | Two-component | Toner 3 | Magnetic carrier 1 |
| | developer 3 | | |
| Example 4 | Two-component | Toner 4 | Magnetic carrier 1 |
| | developer 4 | | |
| Example 5 | Two-component | Toner 5 | Magnetic carrier 1 |
| | developer 5 | | |
| Example 6 | Two-component | Toner 6 | Magnetic carrier 1 |
| | developer 6 | | |
| Example 7 | Two-component | Toner 7 | Magnetic carrier 1 |
| | developer 7 | | |
| Example 8 | Two-component | Toner 8 | Magnetic carrier 1 |
| | developer 8 | | |
| Example 9 | Two-component | Toner 9 | Magnetic carrier 1 |
| | developer 9 | | |
| Example 10 | Two-component | Toner 10 | Magnetic carrier 1 |
| | developer 10 | | |
| Example 11 | Two-component | Toner 11 | Magnetic carrier 1 |
| | developer 11 | | |
| Example 12 | Two-component | Toner 12 | Magnetic carrier 1 |
| | developer 12 | | |
| Example 13 | Two-component | Toner 13 | Magnetic carrier 1 |
| | developer 13 | | |
| Example 14 | Two-component | Toner 14 | Magnetic carrier 1 |
| | developer 14 | | |
| Example 15 | Two-component | Toner 15 | Magnetic carrier 1 |
| | developer 15 | | |
| Example 16 | Two-component | Toner 16 | Magnetic carrier 1 |
| | developer 16 | | |
| Example 17 | Two-component | Toner 17 | Magnetic carrier 1 |
| | developer 17 | | |
| Example 18 | Two-component | Toner 18 | Magnetic carrier 1 |
| | developer 18 | | |
| Example 19 | Two-component | Toner 19 | Magnetic carrier 1 |
| | developer 19 | | |
| Comparative | Comparative | Comparative | Magnetic carrier 1 |
| Example 1 | Two-component | Toner 1 | |
| | developer 1 | | |
| Comparative | Comparative | Comparative | Magnetic carrier 1 |
| Example 2 | Two-component | Toner 2 | |
| | developer 2 | | |
| Comparative | Comparative | Comparative | Magnetic carrier 1 |
| Example 3 | Two-component | Toner 3 | |
| | developer 3 | | |

Using developers 1 to 19 and comparative developers 1 to 3, the charge retention properties and the tinting strength were evaluated according to the following methods.

### Charge Retention Rate Under High-Temperature and High-Humidity Environment

Paper sheet: high-white paper sheet [GFC-081 (81.0 g/m²) (Canon Marketing Japan Inc.)]
Amount of toner deposited on a paper sheet: 0.35 mg/cm²
(adjusted by the DC voltage VDC of the developer-bearing member, the charging voltage VD of the electrostatic latent image bearing member, and the laser power)
Image to be evaluated: A 2 cm×5 cm image was placed at the center of the A4 paper sheet.
Fixing test environment: High temperature and high humidity environment (H/H environment) Temperature: 30° C./Humidity: 80% RH
Process speed: 377 mm/sec

The triboelectric charge quantity of the toner was calculated by aspirating and collecting the toner on an electrostatic latent image bearing member using a metal cylindrical tube and a cylindrical filter. Specifically, the triboelectric charge quantity of a toner on the electrostatic latent image bearing member was measured using a Faraday cage. The Faraday cage is a coaxial double cylinder with the inner and outer cylinders insulated from each other. When a charged body with an electric charge quantity Q is placed in the inner cylinder, it is as if a metallic cylinder with an electric charge quantity Q exists by electrostatic induction. The induced charge quantity was measured by an electrometer (Keithley 6517A manufactured by Keithley Instruments), and the electric charge quantity Q (mC) was divided by the mass M (kg) of a toner in the inner cylinder (Q/M) was defined as the triboelectric charge quantity of the toner.

Triboelectric Charge Quantity (mC/Kg) of Toner=Q/M

First, the evaluation image was formed on the electrostatic latent image bearing member, and before the image was transferred onto the intermediate transfer member, the rotation of the electrostatic latent image bearing member was stopped, the toner on the electrostatic latent image bearing member was aspirated and collected using a cylindrical metal tube and a cylindrical filter, and the [initial Q/M] was measured.

Subsequently, the developing device was left to stand in the evaluating device in an H/H environment for 2 weeks. Then, the same operation as before the standing was conducted, and the electric charge quantity Q/M (mC/kg) per unit mass on the electrostatic latent image bearing member after standing was measured. The Q/M per unit mass on the initial electrostatic latent image bearing member mentioned above was taken as 100%, and the Q/M retention rate ([Q/M after standing]/[initial Q/M]×100) per unit mass on the electrostatic latent image bearing member after standing was calculated and judged based on the following criteria. The evaluation results are shown in Table 5.

### Evaluation Criteria

A: Retention rate was 95.0% or more
B+: Retention rate was 93.0% or more, and less than 95.0%
B: Retention rate was 90.0% or more, and less than 93.0%
B−: Retention rate was 88.0% or more, and less than 90.0%
C+: Retention rate was 86.0% or more, and less than 88.0%
C: Retention rate was 85.0% or more, and less than 86.0%
C−: Retention rate was 84.0% or more, and less than 85.0%
D: Retention rate was less than 84.0%

### Method for Evaluating Tinting Strength of Toner

The evaluation was performed under the environment at an ordinary temperature and an ordinary humidity (23° C., 50% RH) using ordinary copy paper CS-068 (A4 paper sheet, basis weight: 68 g/m², available from Canon Marketing Japan Inc.) as the paper sheet for evaluation.

First, in this evaluation environment, an AC component with an amplitude of 1000 V and a frequency of 9 kHz was applied as the developing bias. Then, the DC component was set to −350 V relative to the highlight potential of −2θ0 V and shadow potential of −500 V of the photosensitive drum. Image output was performed under constant conditions, and the output image density was examined. The image density was measured using the X-Rite Color Reflection Densitometer (500 series, manufactured by X-Rite, Inc.). The tinting strength of toners was evaluated from the results of an X-Rite color reflection densitometer according to the following criteria. The evaluation results are shown in Table 5.

Evaluation criteria
A: 1.97 or more
B+: 1.94 or more, and less than 1.97
B: 1.90 or more, and less than 1.94
B−: 1.88 or more, and less than 1.90
C+: 1.87 or more, and less than 1.88
C: 1.86 or more, and less than 1.87
C−: 1.85 or more, and less than 1.86
D: Less than 1.85

TABLE 5

| | | Charge | | | |
|---|---|---|---|---|---|
| | | retention properties | | | |
| | | | Charge | Tinting strength | |
| Example | Two-component | | retention | | Image |
| No. | developer No. | Rank | rate (%) | Rank | density |
| Example 1 | Two-component | A | 97.0 | A | 1.97 |
| | developer 1 | | | | |
| Example 2 | Two-component | B | 91.0 | B+ | 1.94 |
| | developer 2 | | | | |
| Example 3 | Two-component | B+ | 94.0 | B+ | 1.94 |
| | developer 3 | | | | |
| Example 4 | Two-component | B+ | 94.0 | B+ | 1.94 |
| | developer 4 | | | | |
| Example 5 | Two-component | B | 92.8 | B | 1.90 |
| | developer 5 | | | | |
| Example 6 | Two-component | B− | 88.6 | B | 1.90 |
| | developer 6 | | | | |
| Example 7 | Two-component | B | 91.0 | B | 1.90 |
| | developer 7 | | | | |
| Example 8 | Two-component | B | 91.0 | B | 1.90 |
| | developer 8 | | | | |
| Example 9 | Two-component | B | 89.8 | B− | 1.88 |
| | developer 9 | | | | |
| Example 10 | Two-component | B− | 88.0 | C+ | 1.87 |
| | developer 10 | | | | |
| Example 11 | Two-component | B− | 88.6 | B− | 1.88 |
| | developer 11 | | | | |
| Example 12 | Two-component | B− | 88.6 | B− | 1.88 |
| | developer 12 | | | | |
| Example 13 | Two-component | B− | 88.0 | B− | 1.88 |
| | developer 13 | | | | |
| Example 14 | Two-component | C | 85.0 | C+ | 1.87 |
| | developer 14 | | | | |
| Example 15 | Two-component | B− | 88.0 | C+ | 1.87 |
| | developer 15 | | | | |
| Example 16 | Two-component | B− | 88.0 | C+ | 1.87 |
| | developer 16 | | | | |
| Example 17 | Two-component | C+ | 86.8 | C | 1.86 |
| | developer 17 | | | | |
| Example 18 | Two-component | C+ | 86.0 | C− | 1.85 |
| | developer 18 | | | | |
| Example 19 | Two-component | C | 85.0 | C− | 1.85 |
| | developer 19 | | | | |
| Comparative | Comparative | D | 82.0 | D | 1.83 |
| Example 1 | Two-component | | | | |
| | developer 1 | | | | |
| Comparative | Comparative | C+ | 86.0 | D | 1.81 |
| Example 2 | Two-component | | | | |
| | developer 2 | | | | |
| Comparative | Comparative | D | 83.5 | C− | 1.85 |
| Example 3 | Two-component | | | | |
| | developer 3 | | | | |

It is believed that, in Comparative Example 1, since the distance between PY185 molecules was short, and the interlayer electron state among the PY185 molecules was strongly formed, electrons in the pigment particles would be liable to transfer. Therefore, it is presumed that the leakage of the charge was liable to occur in comparative toner 1, and the charge retention properties were lowered. In the comparative developer 1, the pigment P0 used was not pulverized by a mechanical pulverizer, and no compressive load was applied to the crystals of the pigment. Therefore, it is believed that the pigment particles were difficult to loosen, and the dispersion in the toner was insufficient, resulting in a lowered tinting strength of the toner.

In Comparative Example 2, the XRD diffraction pattern of the extracted pigment had a peak at 2θ=3.40°, indicating a peak shift compared to that of 4.15° in Example 1. It is inferred that in Comparative Example 2, since the distance between PY185 molecules is so long that the electron transition caused by the absorption of visible light on the PY185 molecules would hardly occur, lowering the tinting strength. It is believed that the pigment crystals were considerably deformed by the compression load applied to the pigment in Comparative Example 2. It is thus inferred that this led to a decrease in tinting strength.

In Comparative Example 3, the XRD diffraction pattern of the extracted pigment had a peak at 2θ=4.60°. It is believed that the distance between PY185 molecules was so short that the charge retention properties were lowered in Comparative Example 3. The peak position in Comparative Example 3 means, for example, that the peak is present at a higher-angle side than 4.15° in Example 1, that is, the distance between PY185 molecules is shorter than in Example 1. A short distance between PY185 molecules promotes the formation of a layered electronic state among the PY185 molecules and facilitates the transfer of electrons in the pigment particles. It is thus presumed that the leakage of electric charge would be liable to occur, thereby lowering the charge retention properties.

The present disclosure provides a toner that contains PY185 and exhibits excellent charge retention properties and high tinting strength. Also, the present disclosure provides a method for producing a toner that contains PY185 and exhibits excellent charge retention properties and high tinting strength.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-019386, filed Feb. 7, 2025, which is hereby incorporated by reference herein in its entirety.

What is claimed is:

1. A toner comprising a toner particle comprising a binder resin and C.I. Pigment Yellow 185, wherein
the toner has a peak observed at a diffraction angle 2θ=4.00°±0.50° in an X-ray diffraction measurement using CuKα rays of a sample separated from the toner in procedure 1 described below:
Procedure 1:
add 160 g of sucrose to 100 mL of ion-exchanged water and dissolve the sucrose while heating in hot water to prepare a sucrose concentrate solution; put 31 g of the sucrose concentrated solution and 6 mL of a 10 mass % aqueous solution of a pH 7 neutral detergent for precision instrument cleaning comprising a nonionic surfactant, an anionic surfactant, and an organic builder in a centrifugation tube to prepare a mixture; add 2.0 g of the toner to this mixture, and loosen a lump of the toner with a spatula or a similar tool;
next, shake the centrifugation tube by a shaker; after shaking, separate a precipitate from a dispersion comprising the toner by a centrifuge under conditions at a rotation speed of 3500 rpm for 30 minutes and a rotation radius of 3 cm; filtrate floating powder in a vacuum filtration apparatus and dry the powder at 40° C. for 1 hour or longer in a drier to obtain a dried powder; dissolve 1 g of the resulting powder in 20 mL of chloroform to form a solution, centrifuge the solution at a rotation speed of 15000 rpm and a rotation radius of 3 cm for 180 minutes, and discard supernatant;
further add 20 mL of chloroform thereto, and repeat these operations twice to separate a precipitate; and filtrate a resulting precipitate in a vacuum filtration apparatus, and then dry a resulting solid in a drier at 40° C. for 5 hours or longer to prepare the sample.

2. The toner according to claim 1, wherein
a peak is observed at a diffraction angle 2θ=27.00°±0.50° in an X-ray diffraction measurement using CuKα rays of the sample separated from the toner, and
a ratio of a peak intensity at a diffraction angle 2θ=4.00°±0.50° to a peak intensity at a diffraction angle 2θ=27.00°±0.50° is 0.10 to 1.00.

3. The toner according to claim 1, wherein
a peak is observed at a diffraction angle of 2θ=27.00°±0.50° in an X-ray diffraction measurement using CuKα rays of the sample separated from the toner, and
a crystallite diameter of a crystal attributed to a diffraction angle 2θ=27.00°±0.50° is 10.0 to 13.0 nm.

4. A toner production method for producing the toner according to claim 1,
the toner production method comprising:
a pigment pulverization step of pulverizing the C.I. Pigment Yellow 185; and
a step for producing the toner using the pulverized C.I. Pigment Yellow 185,
a pulverizer, which is used in the pigment pulverization step, introducing a dehumidified gas into an apparatus together with a material to be pulverized; and
the dehumidified gas introduced having a temperature Tin (° C.) of −10° C. to 40° C.

5. The toner production method according to claim 4,
wherein the pulverizer is configured to discharge the introduced dehumidified gas to outside after the pulverization, and
a temperature Tout (° C.) of the dehumidified gas discharged to outside the pulverizer is at least 20° C. and lower than 60° C.
